(19) United States
(12) Patent Application Publication
(10) Pub. No.: US 2008/0183583 A1
(43) Pub. Date: Jul. 31, 2008

(54) METHOD AND SYSTEM FOR PLACING A PURCHASE ORDER VIA A COMMUNICATION NETWORK

(76) Inventor: Witold FERENC, Warsaw (PL)

Correspondence Address: NILS H. LJUNGMAN & ASSOCIATES, P. O. BOX 130, GREENSBURG, PA, 15601-0130, US

(21) Appl. No.: 12/020,697

(22) Filed: Jan. 28, 2008

Related U.S. Application Data
(60) Provisional application No. 60/887,129, filed on Jan. 29, 2007.

(51) Int. Cl. G06Q 30/00; G06F 15/16; G06F 7/00

(52) U.S. Cl. 705/14; 709/206; 707/104.1; 705/27

(57) ABSTRACT

A method of ordering an item using a user mobile device and a system for processing such request. A user is provided with an item information identifying the item, the item information comprising an item description and an item identifier. The user requests to order the item by sending a short-text-message from the user mobile device to a server system identified by a server system identifier, the short-text-message comprising the item identifier, whereby sending the short-text-message is not a part of on-line dialogue with the server system through an Internet service. The server system receives and processes the short-text-message, generating an order to purchase the item based on the information comprised in the short-text-message and the user information previously stored in a customer database.

### TECHNICAL FIELD

The present invention relates to a method and a system for placing an order and, more particularly, to a method and a system for ordering items using Internet shops.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

The World Wide Web is especially conducive to conducting electronic commerce. Many Web servers have been developed through which vendors can advertise and sell product. The products can include items (e.g. music) that are delivered electronically to the purchaser over the Internet and items (e.g. books) that are delivered through conventional distribution channels (e.g. a common carrier). A server computer system, an Internet shop, may provide an electronic version of a catalog that lists the items that are available. A user, who is a potential purchaser, may browse through the catalog using a browser and select various items that are to be purchased. When the user has completed selecting the items to be purchased, the server computer system then prompts the user for information to complete the ordering of the items. This purchaser-specific order information may include the purchaser's name, the purchaser's credit card number, and a shipping address for the order. The server computer system then typically confirms the order by sending a confirming Web page to the client computer system and schedules shipment of the items.

The United States patent document U.S. Pat. No. 5,960,411 describes improved system and method of conducting electronic commerce over the Internet. The client system is provided with an identifier that identifies a customer. The client system displays information that identifies the item and displays an indication of a single-action, such as clicking a mouse button, that a purchaser is to perform to order the identified item. In response to the indicated action being performed, the client system sends to a server system the provided identifier and a request to order the identified item. The server system uses the identifier to retrieve previously stored additional information, needed to generate an order for the item and then generates the order.

The server system receives and stores the additional information for customers using various computer systems so that the server system can generate such orders. The server system stores the received additional information in association with an identifier of the customer and provides the identifier to the client system. When requested by the client system, the server system provides information describing the item to the requesting client system. When the server system receives a request from a client system, the server system combines the additional information stored in association with the identifier included in the request to effect the ordering of the item.

Such single-action ordering system reduces the number of purchaser interactions needed to place an order and reduces the amount of information that is transmitted between a client system and a server system, in particular sensitive information, such as credit card details. Moreover, such system and method facilitates Internet shopping without using a shopping cart ordering model.

What is important to notice is that, in the above system and method, the single-action ordering is a part of on-line dialogue through the Internet—the server system provides information describing an item to the client system, which system, in response, may use the single-action to order the item.

Thus, a problem arises when product information and/or ordering information are to be delivered without direct access to the Internet by a user.

It is an object of the invention to obviate this problem.

### SUMMARY OF THE INVENTION

The object of the invention is achieved, according to a first aspect, by a method of ordering an item using a user mobile device provided with a user identifier, the method comprising:

providing to a user an item information identifying the item, the item information comprising an item description and an item identifier;

requesting to order the item by sending a short-text-message from the mobile user device to a server system identified by a server system identifier, the short-text-message comprising the item identifier, whereby sending the short-text-message is not a part of on-line dialogue with the server system through an Internet service;

receiving the short-text-message accompanied by the user identifier by the server system;

retrieving user information previously stored for the user identified by the user identifier;

generating an order to purchase the item for the user identified by the user identifier using the user information; and

fulfilling the order to complete purchase of the item.

The method of the invention provides a simple way of placing purchase orders without direct access to the Internet.

In an embodiment of the method, the user identifier comprises a mobile telephone number of the user. Such number is a simple identifier associated with the short-text-message.

In another embodiment of the method, the user mobile device is a mobile telephone, which is a specific class of mobile devices.

In a further embodiment of the method, the user mobile device is a personal digital assistant comprising a mobile telephony module capable of sending short-text-messages.

Advantageously, the short-text-message comprises a plurality of item identifiers corresponding to different items. This further simplifies purchase by ordering many items using a single short-text-message.

In an embodiment of the method, the short-text-message additionally comprises a number defining quantity of the item to be ordered.

In another embodiment of the method, one order to purchase a plurality of items is generated for a plurality of short-text-messages received by the server system within a predefined period of time. This makes it possible to prepare one shipment of goods ordered within that period of time.

It is advantageous, if the short-text-message additionally comprises a verification string for validating the short-text-message before it is processed by the server system. This improves protection against accidental or unauthorized orders.

In a further embodiment of method, the server system requests the user to send additional short-text-message confirming the original request before generating the order. The server system request may be for example in a form of a short-text-message sent from the server system to the user. Such short-text-message sent from the server system to the user may further comprise information about the order to purchase (e.g. price, quantity, etc.) for a purpose of verification of such information by the user. This facilitates another way of protection against accidental or unauthorized orders.

In an embodiment of the method, the user provides additional information to the server system through additional channel such as an Internet service, for generating the order. This further improves protection against accidental or unauthorized orders.

In another embodiment of the method, the item information is provided to the user through an advertising short-text-message. In this embodiment the user mobile device serves not only for placing orders, but also for receiving the item information.

In yet another embodiment of the method, the server system identifier comprises an e-mail address of the server system, the short-text-message additionally comprises the e-mail address of the server system, and the short-text-message is converted into an e-mail message before being delivered to the server system. This allows for using short-text-messages for placing orders at systems accepting orders via e-mail.

In an embodiment of the method, the user identifier comprises an e-mail address of the user. This can be used alternatively or in addition to the mobile telephone number.

According to a second aspect of the invention a server system for processing requests to purchase items is provided, the server system comprising:

a customer database for storing information records of a plurality of users, each record comprising user information and a user identifier identifying a particular user;

an item database for storing information records of a plurality of items, each record comprising at least an item identifier identifying a particular item;

a short-text-message component for processing a short-text-message received from a mobile user device, the mobile user device provided with a user identifier, the short-text-message comprising an item identifier and accompanied by the user identifier, the short-text-message sent not as a part of on-line dialogue with the server system through an Internet service;

a retrieving component for retrieving the user information for the user identified by the user identifier;

an order component for generating an order to purchase the item identified by the item identifier using the user information.

According to a third aspect of the invention a computer program product is provided, for use by a server system in processing requests to purchase, which program is operative to cause a processor of the server system to perform the method of the invention.

### BRIEF DESCRIPTION OF THE DRAWINGS

These and other aspects of the invention will be apparent from and elucidated further with reference to the embodiments described by way of example in the following description and with reference to the accompanying drawings, in which:

FIG. 1 shows an example of a method of ordering, in accordance with the invention;

FIG. 2 shows an example of a simple short-text-message comprising an item identifier as displayed on a screen of a user mobile device, in accordance with the invention;

FIG. 3 shows an example of a server system for processing requests to purchase items, according to the invention.

Corresponding elements in different Figures have identical reference numerals.

### DETAILED DESCRIPTION OF THE INVENTION

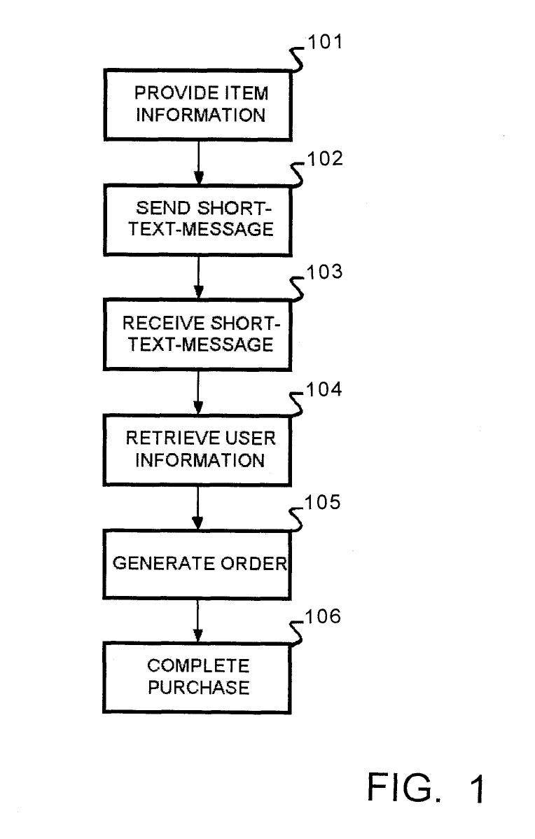

FIG. 1 shows an example of the method of the present invention. In a step 101, a user is provided with item information identifying the item, the item information comprising an item description and an item identifier. The item information can be provided through visual, hearing or touch senses. For example, the item information can be displayed on a computer screen or a television screen. It can be displayed as an element of a Web page of Internet shopping. Alternatively, it can be comprised in a printed catalogue of items. It can also be presented in the form of a poster, a billboard or as an advertisement in a paper or newspaper. In another embodiment, the item information is provided to the user as a sound announcement, for example during radio transmission. In a very specific embodiment of the method, the item information is communicated to the user by touch as a Braille's text.

In a step 102, the user requests to order the item by sending a short-text-message, such as Short Message Service, SMS, from a user mobile device to a server system identified by a server system identifier, the short-text-message comprising the item identifier, whereby sending the short-text-message is not a part of on-line dialogue with the server system through an Internet service. This can happen in several situations, such as:
the item information had been delivered during usual Internet shopping session, but then the Internet connection was broken;
the item information had been delivered during usual Internet shopping session, but then the user decided to order the item at a later time instance using the item identifier;
the user was acquainted with the item information not through the Internet;
the user mobile device is incapable of performing direct Internet communication;
the user mobile device is capable of performing direct Internet communication, but the user decides to use cheaper short-text-messaging.

The user mobile device is a mobile telephone or a mobile device, such as Personal Digital Assistant, comprising a mobile telephony module capable of sending short-text-messages. The user mobile device is provided with a user identifier. In an embodiment of the method the user identifier is simply a mobile telephone number, such as the number associated with a Subscriber Identity Module, SIM-card, within the user mobile device. The short-text-message is sent from the user mobile device via a mobile telecommunication network. With respect to this, it has to be emphasized that a short-text-message in the context of the present invention should not be misinterpreted as an e-mail message known from the Internet-like communication networks. Of course, modern mobile telecommunication networks are capable of establishing Internet connections and transmitting e-mail messages through them. However, this functionality is provided by higher-level layers of mobile networks. On contrary, the invention teaches to use very simple, fast and cheap text messages transmitted via a basic layer of a mobile telecommunication network. In one specific embodiment of the invention, a short-text-message originating from a user mobile device and transmitted via a mobile telecommunication network is converted into an e-mail message before being delivered to a server system, as explained later in the description.

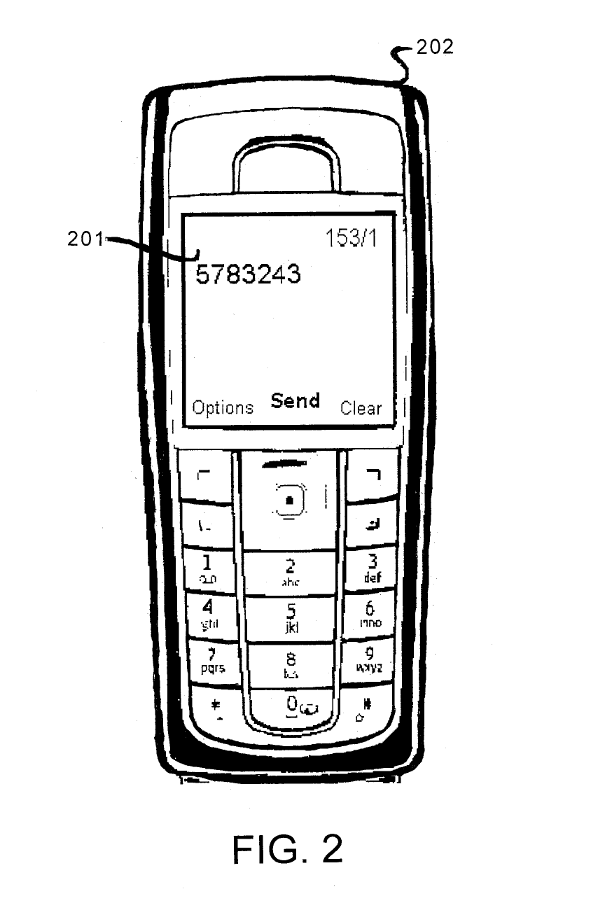

FIG. 2 shows an example of a simple short-text-message comprising an item identifier 201 as displayed on a screen of a user mobile device 202.

In a particular embodiment of the method, the item information is provided to the user through an advertising short-text-message received by the user mobile device.

In an embodiment, the short-text-message additionally comprises a number defining quantity of the item to be ordered. For example, to allow the user to purchase two copies of the same book using one short-text-message.

In an embodiment, the step 102 is modified, so the short-text-message comprises a plurality of item identifiers corresponding to different items. This allows for ordering more than one item with a single short-text-message.

In another embodiment, the step 102 is modified, so the short-text-message additionally comprises a verification string for validating the short-text-message before it is processed by the server system. This password-like or PIN-like string improves protection against accidental or unauthorized orders.

In other embodiment, the step 102 is modified, so the short-text-message is encrypted.

The short-text-message accompanied by the user identifier is received by the server system, in a step 103.

The user identifier may be automatically attached to the short-text-message by the user mobile device or manually inserted into the message itself by the user.

The user identifier may comprise an e-mail address of the user. This e-mail address can be used by the server system for verifying the user in addition or instead of the user mobile telephone number.

In an embodiment of the method, the server system identifier is a server system telephone number, which number is used by the server system for communicating with the mobile telecommunication network.

In another embodiment, the server system identifier comprises an e-mail address of the server system, the short-text-message additionally comprises the e-mail address of the server system, and the short-text-message is converted into an e-mail message before being delivered to the server system. This embodiment can be used, for example, in situations when the server system telephone number is not available for the user, but the server system accepts e-mail messages for generating purchase orders. Conversion of the short-text-message into an e-mail message is done by the mobile communication network and the resulting e-mail can be delivered to the server system via the Internet. Often, in the mobile communication network, a mailbox is associated with the user mobile telephone number. Then, during said conversion, the user mobile telephone number may be masked by an e-mail address of the mailbox and delivered to the server system. This e-mail address can be used by the server system as the user identifier.

In a step 104, the system server retrieves user information previously stored for the user identified by the user identifier. For example, the user information can be stored during any Internet shopping session preceding ordering by the short-text-message. The user information may include the user's name, the user's credit card number and a shipping address for the order. In addition, the user information may comprise verification information, such as the user mobile telephone number, the e-mail address of the user or other password-like or PIN-like information for verifying against information received in/with the short-text-message.

In an embodiment, the server system requests the user to send additional short-text-message confirming the original request before generating the order. For example, the server system can send a short-text-message with the text “ARE YOU CONFIRMING YOUR ORDER OF ITEM #?”. In response, the user may send additional message reading, for example, “YES” or “NO”.

Next, in a step 105, an order is generated to purchase the item for the user identified by the user identifier using the user information and finally the order to complete purchase of the item is fulfilled in a step 106.

In an embodiment of the method, the step 105 is modified so one order to purchase a plurality of items is generated for a plurality of short-text-messages received by the server system within a predefined period of time. For example, one purchase order is created for all short-text-messages received from the user within one day.

In another embodiment, the user provides additional information to the server system through additional channel such as an Internet service, for generating the order. For example, the server system may collect ordering information delivered by at least one short-text-message, but wait with generating the actual order till the user completes a purchase by providing necessary information during Internet shopping. This additional information may be complementary to or may comprise some elements of the user information, for example a credit card number. In this model, sending short-text-messages correspond to filling a shopping cart during Internet shopping.

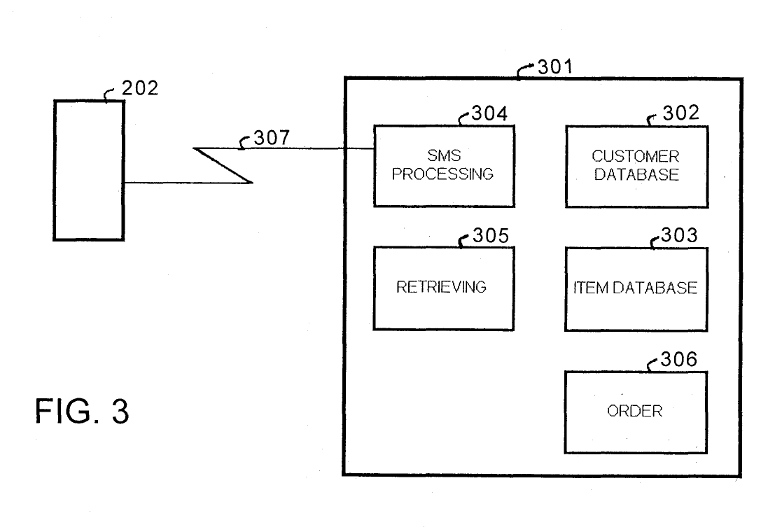

FIG. 3 shows an example of a server system 301 for processing requests to purchase items, according to the invention. It comprises:

a customer database 302 for storing information records of a plurality of users, each record comprising user information and a user identifier identifying a particular user;

an item database 303 for storing information records of a plurality of items, each record comprising at least an item identifier identifying a particular item;

a short-text-message component 304 for processing a short-text-message received from a mobile user device, the mobile user device provided with a user identifier, the short-text-message comprising an item identifier and accompanied by the user identifier, the short-text-message sent not as a part of on-line dialogue with the server system through an Internet service;

a retrieving component 305 for retrieving the user information for the user identified by the user identifier;

an order component 306 for generating an order to purchase the item identified by the item identifier using the user information.

The short-text-message component 304 communicates with a mobile telecommunication network 307 for receiving short-text-messages. Further the short-text-message component 304 retrieves the item identifier and the user identifier received with the short-text-message. The user identifier is verified against the customer database.

In an embodiment of the server system, the short-text-message component 304 is adapted to process the short-text-message comprising a plurality of item identifiers corresponding to different items.

In another embodiment, the short-text-message component 304 is adapted to process the short-text-message additionally comprising a number defining quantity of the item to be ordered.

Advantageously, the order component 306 is adapted to generate one order to purchase a plurality of items for a plurality of short-text-messages received by the server system within a predefined period of time.

In a further embodiment, the server system comprises a validation component (not shown in FIG. 3) for validating the short-text-message by checking a verification string comprised in the short-text-message before further processing.

In yet another embodiment, the server system comprises a confirmation component (not shown in FIG. 3) for requesting the user to send additional short-text-message confirming the original request before the order component 306 generates the order.

In an embodiment, the order component is adapted to generate the order only after the server system receives additional information from the user through additional channel such as an Internet service.

In another embodiment, the server system comprises an advertising component (not shown in FIG. 3) for sending advertising short-text-messages comprising item identifiers to the mobile user device.

In a further embodiment, the server system comprises an e-mail message component (not shown in FIG. 3) for processing e-mail messages originating from short-text-messages converted to the e-mail messages by the mobile telecommunication network.

Further embodiments of the server system are capable of performing functions as described above with reference to embodiments of the method of the invention.

It should be pointed out that the server system may comprise further components, such as a Web component for facilitating Internet shopping as known in the art, and in particular from the document U.S. Pat. No. 5,960,411.

Embodiments of a computer program product according to the invention are operative to cause a processor in the server system to perform the method of the invention as described in reference to embodiments presented above.

Whilst the invention has been described with reference to preferred embodiments thereof, it is to be understood that these are not limiting examples. Thus, various modifications may become apparent to those skilled in the art, without departing from the scope of the invention, as defined by the claims. Furthermore, the invention lies in each and every novel feature or combination of features described above. It is noted, that the invention may be implemented by means of a general purpose processor executing a computer program or by dedicated hardware or by a combination of the two, and that in this document the word “comprising” does not exclude the presence of other elements or steps than those listed and the word “a” or “an” preceding an element does not exclude the presence of a plurality of such elements, that any reference signs do not limit the scope of the claims, that “component” may be represented by a single item or a plurality and that several “components” may be represented by the same item of hardware or software.

1. A method of ordering an item using a user mobile device provided with a user identifier, the method comprising:
providing to a user an item information identifying the item, the item information comprising an item description and an item identifier;
requesting to order the item by sending a short-text-message from the user mobile device to a server system identified by a server system identifier, the short-text-message comprising the item identifier, whereby sending the short-text-message is not a part of on-line dialogue with the server system through an Internet service;
receiving the short-text-message accompanied by the user identifier by the server system;
retrieving user information previously stored for the user identified by the user identifier;
generating an order to purchase the item for the user identified by the user identifier using the user information; and
fulfilling the order to complete purchase of the item.

2. The method as claimed in claim 1, wherein the user identifier comprises a mobile telephone number of the user.

3. The method as claimed in claim 1, wherein the user mobile device is a mobile telephone.

4. The method as claimed in claim 1, wherein the user mobile device is a personal digital assistant comprising a mobile telephony module capable of sending short-text-messages.

5. The method as claimed in claim 1, wherein the short-text-message comprises a plurality of item identifiers corresponding to different items.

6. The method as claimed in claim 1, wherein the short-text-message additionally comprises a number defining quantity of the item to be ordered.

7. The method as claimed in claim 1, wherein one order to purchase a plurality of items is generated for a plurality of short-text-messages received by the server system within a predefined period of time.

8. The method as claimed in claim 1, wherein the short-text-message additionally comprises a verification string for validating the short-text-message before it is processed by the server system.

9. The method as claimed in claim 1, wherein the server system requests the user to send additional short-text-message confirming the original request before generating the order.

10. The method as claimed in claim 1, wherein the user provides additional information to the server system through additional channel such as an Internet service, for generating the order.

11. The method as claimed in claim 1, wherein the item information is provided to the user through an advertising short-text-message.

12. The method as claimed in claim 1, wherein the server system identifier comprises an e-mail address of the server system, the short-text-message additionally comprises the e-mail address of the server system, and the short-text-message is converted into an e-mail message before being delivered to the server system.

13. The method as claimed in claim 12, wherein the user identifier comprises an e-mail address of the user.

14. A server system for processing requests to purchase items, the server system comprising:
a customer database for storing information records of a plurality of users, each record comprising user information and a user identifier identifying a particular user;
an item database for storing information records of a plurality of items, each record comprising at least an item identifier identifying a particular item;
a short-text-message component for processing a short-text-message received from a mobile user device, the mobile user device provided with a user identifier, the short-text-message comprising an item identifier and accompanied by the user identifier, the short-text-message sent not as a part of on-line dialogue with the server system through an Internet service;
a retrieving component for retrieving the user information for the user identified by the user identifier;
an order component for generating an order to purchase the item identified by the item identifier using the user information.

15. The server system as claimed in claim 14, wherein the user identifier comprises a mobile telephone number of the user.

16. The server system as claimed in claim 14, wherein the short-text-message component is adapted to process the short-text-message comprising a plurality of item identifiers corresponding to different items.

17. The server system as claimed in claim 14, wherein one of:
the short-text-message component is adapted to process the short-text-message additionally comprising a number defining quantity of the item to be ordered; and
the order component is adapted to generate one order to purchase a plurality of items for a plurality of short-text-messages received by the server system within a predefined period of time.

18. The server system as claimed in claim 14, comprising one of:
a validation component for validating the short-text-message by checking a verification string comprised in the short-text-message before further processing;
a confirmation component for requesting the user to send additional short-text-message confirming the original request before generating the order.

19. The server system as claimed in claim 14, wherein one of:
the order component is adapted to generate the order only after the server system receives additional information from the user through additional channel such as an Internet service; and
the server system comprising an advertising component for sending advertising short-text-messages comprising item identifiers to the mobile user device.

20. A computer program product for use by a server system in processing requests to purchase, which program is operative to cause a processor of the server system to perform a method comprising:
providing to a user an item information identifying the item, the item information comprising an item description and an item identifier;
requesting to order the item by sending a short-text-message from the user mobile device to a server system identified by a server system identifier, the short-text-message comprising the item identifier, whereby sending the short-text-message is not a part of on-line dialogue with the server system through an Internet service;
receiving the short-text-message accompanied by the user identifier by the server system;
retrieving user information previously stored for the user identified by the user identifier;
generating an order to purchase the item for the user identified by the user identifier using the user information;
fulfilling the order to complete purchase of the item; and
wherein one of (A), (B), (C), (D), (E), (F), (G), (H), (I), (J) and (K):
(A) the user identifier comprises a mobile telephone number of the user;
(B) the user mobile device is a mobile telephone;
(C) the user mobile device is a personal digital assistant comprising a mobile telephony module capable of sending short-text-messages;
(D) the short-text-message comprises a plurality of item identifiers corresponding to different items;
(E) the short-text-message additionally comprises a number defining quantity of the item to be ordered;
(F) one order to purchase a plurality of items is generated for a plurality of short-text-messages received by the server system within a predefined period of time;
(G) the short-text-message additionally comprises a verification string for validating the short-text-message before it is processed by the server system;
(H) the server system requests the user to send additional short-text-message confirming the original request before generating the order;
(I) the user provides additional information to the server system through additional channel such as an Internet service, for generating the order;
(J) the item information is provided to the user through an advertising short-text-message; and
(K) the server system identifier comprises an e-mail address of the server system, the short-text-message additionally comprises the e-mail address of the server system, and the short-text-message is converted into an e-mail message before being delivered to the server system, and wherein the user identifier comprises an e-mail address of the user.
